(19) United States
(12) Patent Application Publication
(10) Pub. No.: US 2026/0078792 A1
(43) Pub. Date: Mar. 19, 2026

(54) TAPPING SCREW AND METHOD OF MANUFACTURING THE SAME

(71) Applicant: SAMSUNG SDI CO., LTD., Yongin-si (KR)

(72) Inventor: SANGHUN PARK, Yongin-si (KR)

(21) Appl. No.: 19/325,676

(22) Filed: Sep. 11, 2025

(30) Foreign Application Priority Data
Sep. 13, 2024 (KR) 10-2024-0125944

(51) Int. Cl. F16B 25/00; F16B 33/02

(52) U.S. Cl. CPC F16B 25/0042; F16B 33/02

(57) ABSTRACT

A tapping screw and a method of manufacturing the tapping screw are disclosed. The tapping screw may include a head part and a screw part that is beneath the head part and that has a thread on an outer periphery of a minor diameter circle thereof, wherein the screw part has a receiving groove on a portion thereof to receive by-products from a body as the screw part progresses through the body.

### CROSS-REFERENCE TO RELATED APPLICATION

The present application claims priority to and the benefit of Korean Patent Application No. 10-2024-0125944, filed on Sep. 13, 2024, in the Korean Intellectual Property Office, the entire disclosure of which is incorporated herein by reference.

### BACKGROUND

### 1. Field

One or more embodiments of the present disclosure relate to a tapping screw and a method of manufacturing the tapping screw, and, for example, to a tapping screw having a receiving groove to receive by-products cut by tapping and a method of manufacturing the tapping screw.

### 2. Description of the Related Art

Unlike primary batteries that are not designed to be charged, secondary batteries are designed to be discharged and recharged. Low-capacity secondary batteries are used in small portable electronic devices, such as smart phones, feature phones, notebook computers, digital cameras, camcorders, and/or the like, while large-capacity secondary batteries are used as a driving power source for hybrid vehicles and/or electric vehicles and/or a power storage source for energy storage systems (ESSs). The secondary batteries include an electrode assembly that consists of a positive electrode and a negative electrode, a case that accommodates the electrode assembly, a terminal part connected to the electrode assembly, and/or the like.

A battery pack including multiple secondary batteries often uses screws to fasten casings together and/or to fix components, such as a core pack including (or composed of) multiple battery cells and a battery management system (BMS). These screws are made of metal and are mainly or predominantly used by insertion into a body made of plastic. Because the hard screws are inserted into the relatively soft body in this way, the plastic body may be damaged.

The foregoing information disclosed in this Background section is for enhancement of understanding of the background of the present disclosure, and therefore, it may contain information that does not constitute related art.

### SUMMARY

One or more aspects of embodiments of the present disclosure are directed toward a tapping screw having a receiving groove to receive by-products cut by tapping and a method of manufacturing the tapping screw.

Additional aspects of embodiments will be set forth in part in the description which follows and, in part, will be apparent from the description or may be learned by practice of the presented embodiments of the disclosure.

However, the technical problem to be solved by the present disclosure is not limited to the problem as described in one or more embodiments, and other problems not mentioned herein and aspects and features of the present disclosure that would address such problems will be clearly understood by those skilled in the art from the description of the present disclosure herein.

One or more embodiments of the present disclosure provide a tapping screw that includes a head part and a screw part that is beneath the head part and that has a thread on an outer periphery of a minor diameter circle thereof, wherein the screw part has a receiving groove on a portion thereof to receive by-products cut by tapping performed on a body as the screw part progresses through the body (or to receive by-products from a body as the screw part progresses through the body).

The receiving groove may be in a direction of progress of the screw part. The receiving groove may extend along a length direction of the screw part.

The receiving groove may have, on the basis of a horizontal cross-sectional area of the receiving groove, an area in a range of about 90% to about 110% of the region where the thread interferes with the body.

The receiving groove may have a width that becomes larger as the screw part progresses through the body.

The receiving groove may have a triangular (e.g., substantially triangular) cross-sectional shape.

The receiving groove may have a trapezoidal (e.g., substantially trapezoidal) cross-sectional shape.

The receiving groove may be inclined at an (e.g., a set or predetermined) angle with respect to the direction of the progress of the screw part.

The receiving groove may have a depth that becomes larger as the screw part progresses through the body.

The receiving groove may be exposed to the outside to discharge the by-products from the receiving groove upon completion of fastening following the progress of the screw part (or upon completion of fastening of the screw part to the body).

The tapping screw may further include a breakage prevention part between the head part and the body. The tapping screw may further include a breakage prevention part inserted and positioned or provided between the head part and the body upon completion of fastening following the progress of the screw part (or upon completion of fastening of the screw part to the body).

The breakage prevention part may be a circular (e.g., substantially circular) elastic member.

The breakage prevention part may be a circular (e.g., substantially circular) tube containing air.

One or more embodiments of the present disclosure provide a method of manufacturing tapping screws, which includes manufacturing a tapping screw that includes a head part and a screw part that is beneath the head part and that has a thread on an outer periphery of a minor diameter circle thereof, and forming or providing a receiving groove on a portion of the screw part to receive by-products cut by tapping performed on a body as the screw part progresses through the body (or to receive by-products from a body as the screw part progresses through the body).

In the forming or providing a receiving groove, the receiving groove may be in a direction of progress of the screw part. In the forming or providing a receiving groove, the receiving groove may extend along a length direction of the screw part.

In the forming or providing a receiving groove, the receiving groove may have, on the basis of a horizontal cross-sectional area of the receiving groove, an area in a range of about 90% to about 110% of the region where the thread interferes with the body.

In the forming or providing a receiving groove, the receiving groove may have a width that becomes larger as the screw part progresses through the body.

In the forming or providing a receiving groove, the receiving groove may be inclined at an (e.g., a set or predetermined) angle with respect to the direction of the progress of the screw part.

In the forming or providing a receiving groove, the receiving groove may have a depth that becomes larger as the screw part progresses through the body.

In the forming or providing a receiving groove, the receiving groove may be exposed to the outside to discharge the by-products from the receiving groove upon completion of fastening following the progress of the screw part (or upon completion of fastening of the screw part to the body.

The method may further include manufacturing a breakage prevention part between the head part and the body. The method may further include manufacturing a breakage prevention part inserted and positioned or provided between the head part and the body upon completion of fastening following the progress of the screw part (or upon completion of fastening of the screw part to the body).

However, aspects and features of embodiments of the present disclosure are not limited to the one set forth herein, and other aspects and features not mentioned in the present disclosure will be clearly understood by a person skilled in the art from the present disclosure by referencing the detailed description of the present disclosure given.

### BRIEF DESCRIPTION OF THE DRAWINGS

The accompanying drawings illustrate embodiments of the subject matter of the present disclosure and serve to further describe principles of embodiments of subject matter of the present disclosure together with the detailed description of the present disclosure. Thus, the present disclosure should not be construed as being limited to the accompanying drawings, in which:

FIG. 1 is a schematic view illustrating a cylindrical lithium secondary battery according to one or more embodiments;

FIG. 2 is a schematic view illustrating a prismatic lithium secondary battery according to one or more embodiments;

FIGS. 3 and 4 are schematic views illustrating a pouch-type or kind lithium secondary battery according to one or more embodiments;

FIGS. 5A-5D are views illustrating a casing to which a tapping screw is applicable according to one or more embodiments of the present disclosure;

FIGS. 6A and 6B are views illustrating a body, that is generally available or generally used, to which a screw is fastened;

FIGS. 6C and 6D are views illustrating a body, that is generally available or generally used, with a reinforcement member;

FIG. 7 is a view illustrating a tapping screw according to one or more embodiments of the present disclosure;

FIGS. 8A-8C are views illustrating examples of receiving grooves for the tapping screw according to one or more embodiments of the present disclosure;

FIG. 9 is a cross-sectional view illustrating a state in which the tapping screw is coupled to a body according to one or more embodiments of the present disclosure;

FIGS. 10A and 10B are enlarged views of examples in which the tapping screw is coupled to the body according to one or more embodiments of the present disclosure;

FIGS. 11A-11C are views illustrating an issue due to vertical misalignment when fastening a tapping screw that is generally available or generally used;

FIGS. 12A-12C are views illustrating that the tapping screw includes a breakage prevention part according to one or more embodiments of the present disclosure; and

FIG. 13 is a flowchart illustrating a method of manufacturing tapping screws according to one or more embodiments of the present disclosure.

### DETAILED DESCRIPTION

One or more embodiments of the present disclosure will be described herein in more detail with reference to the accompanying drawings. Prior to the description, it is noted that the terms or words used in the present disclosure and the appended claims and equivalents thereof should not be construed as being limited to common or dictionary meanings but instead should be understood to have meanings and concepts in agreement with the spirit and scope of the present disclosure based on the principle that an inventor may define the concept of each term suitably in order to describe his/her own invention in the best way possible. Accordingly, because one or more embodiments described in the present disclosure and the configurations or arrangements illustrated in the drawings are only an example of the present disclosure and they do not cover all the technical ideas and aspects of one or more embodiments of the present disclosure, it should be understood that one or more suitable changes and modifications may be made at the time of filing this application.

It will be further understood that the terms “has/includes” and/or “having/including” if (e.g., when) used herein, specify the presence of stated features, integers, steps, operations, elements, components, and/or groups thereof, but do not preclude the presence or addition of one or more other features, integers, steps, operations, elements, components, and/or groups thereof.

In the present disclosure, it will be understood that the term “comprise(s)/comprising,” “include(s)/including,” or “have/has/having” specifies the presence of stated features, integers, steps, operations, elements, and/or components, but do not preclude the presence or addition of one or more other features, integers, steps, operations, elements, components, and/or groups thereof. Additionally, the terms “comprise(s)/comprising,” “include(s)/including,” “have/has/having” or similar terms include or support the terms “consisting of” and “consisting essentially of,” indicating the presence of stated features, integers, steps, operations, elements, and/or components, without or essentially without the presence of other features, integers, steps, operations, elements, components, and/or groups thereof.

In order to facilitate understanding of the present disclosure, the accompanying drawings are not drawn to scale, and the dimensions of one or more components may be exaggerated. It should be noted that the same reference numerals are designated to substantially the same components in different embodiments.

Reference to two compared elements, features, and/or the like as being “the same” indicates that they are “substantially the same”. Therefore, the phrase “substantially the same” may include a deviation that is considered low in the art, for example, a deviation of 5% or less. The uniformity of any parameter in a given region may refer to that it is uniform (e.g., substantially uniform) from an average perspective.

Although the terms, such as “first” and/or “second”, are used to describe one or more components, these components are not limited by these terms. These terms are only used to distinguish one component from another component. Thus, unless specifically stated to the contrary, a first component may be termed a second component without departing from the spirit and scope of the present disclosure.

Throughout the specification, unless otherwise stated, each element may be singular or plural.

Arrangement of any component “above (or below)” or “on (or under)” a component may refer to that any component is disposed in contact with the upper (or lower) surface of the component, as well as that other components may be between the element and any element on (or under) the element.

It will be understood that, if (e.g., when) a component is referred to as being “connected”, “coupled”, or “joined” to another component, not only may it be directly “connected”, “coupled”, or “joined” to the other element, but also may it be indirectly “connected”, “coupled”, or “joined” to the other element with other elements interposed therebetween.

As used herein, the term “and/or” includes any and all combinations of one or more of the associate listed items. The use of “may” if (e.g., when) describing embodiments of the present disclosure relates to “one or more embodiments of the present disclosure”. Expressions, such as “at least one” and “one or more”, preceding a list of elements modify the entire list of elements and do not modify the individual elements in the list.

Throughout the specification, if (e.g., when) “A and/or B” is stated, it refers to A, B, or A and B, unless otherwise stated. Also, if (e.g., when) “C to D” is stated, it refers to C or more and D or less, unless specifically stated to the contrary.

If (e.g., when) the phrase, such as “at least one of A, B, and C”, “at least one of A, B, or C”, “at least one selected from the group of A, B, and C”, or “at least one selected from among A, B, and C”, is used to designate a list of elements A, B, and C, the phrase may refer to any and all suitable combinations.

The term “use” may be considered synonymous with the term “utilize”. As used herein, the terms “substantially,” “about,” and similar terms are used as terms of approximation rather than as terms of degree, and are intended to account for inherent variations in measured or calculated values that would be recognized by those of ordinary skill in the art.

It will be understood that, although the terms “first,” “second,” “third,” and/or the like may be used herein to describe one or more elements, components, regions, layers, and/or sections, these elements, components, regions, layers, and/or sections should not be limited by these terms. These terms are used to distinguish one element, component, region, layer, or section from another element, component, region, layer, or section. Accordingly, a first element, a first component, a first region, a first layer, or a first section discussed herein may be termed a second element, a second component, a second region, a second layer, or a second section without departing from the spirit and scope of the present disclosure.

For ease of explanation in describing the relationship of one element or feature to another element(s) or feature(s) as illustrated in the drawings, spatially relative terms, such as “beneath”, “below”, “lower”, “above”, and “upper”, may be used herein. It will be understood that spatially relative positions are intended to encompass different directions of the device in use or operation in addition to the direction depicted in the drawings. For example, if (e.g., when) the device in the drawings is turned over, any element described as being “below” or “beneath” another element may then be oriented “above” or “over” another element. Therefore, the term “below” may encompass both (e.g., simultaneously) upward and downward directions.

The terminology used herein is for the purpose of describing one or more embodiments of the present disclosure and is not intended to limit the scope of the present disclosure.

Unless otherwise defined, all terms (including technical and scientific terms) used herein have substantially the same meaning as generally understood by one of ordinary skill in the art to which the present disclosure belongs. It will be further understood that terms, such as those defined in dictionaries that are generally available or generally used, should be interpreted as having a meaning that is consistent with their meaning in the context of the relevant art and will not be interpreted in an idealized or overly formal sense unless expressly so defined herein.

The type or kind of secondary battery may include a coin type or kind, a cylindrical type or kind, a prismatic type or kind, and a pouch type or kind. Prior to a description of one or more embodiments of the present disclosure, cylindrical and prismatic secondary batteries are described in more detail herein because one or more embodiments of the present disclosure may be applied to the cylindrical and prismatic secondary batteries.

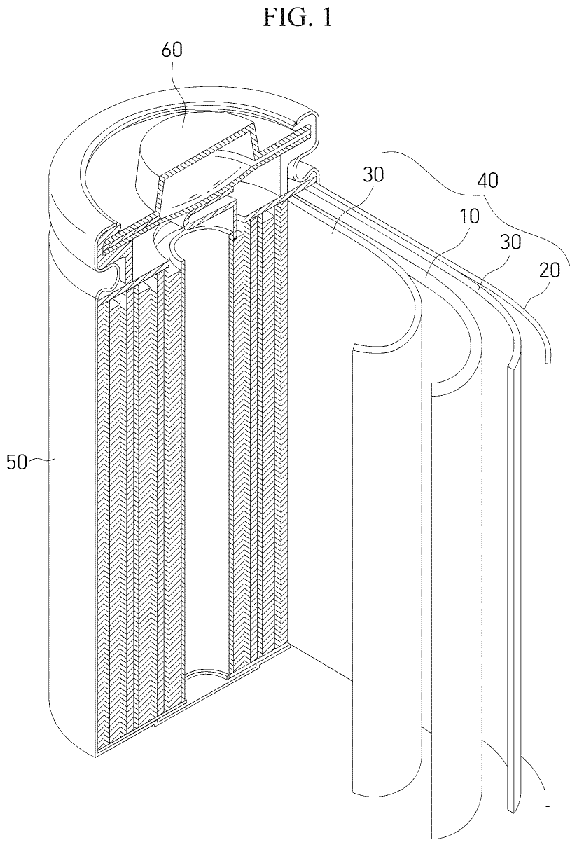

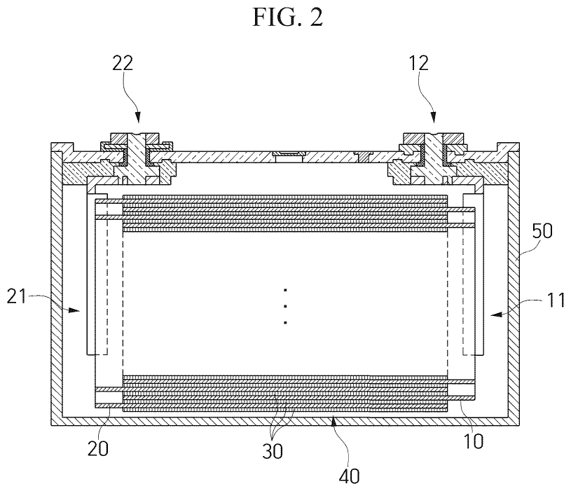

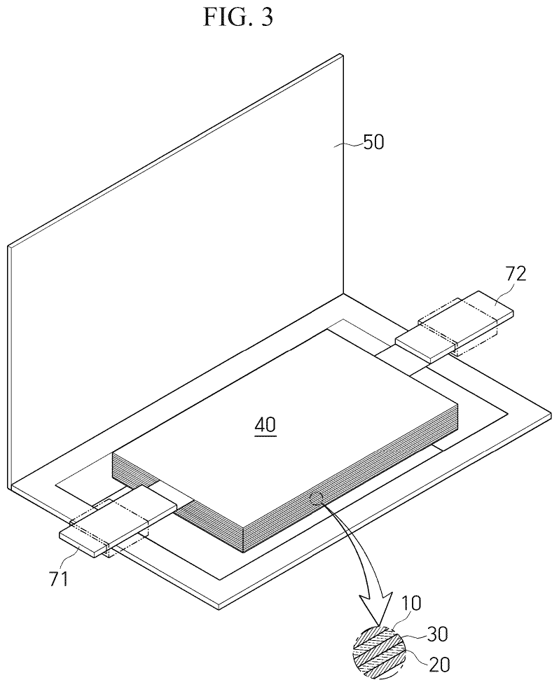

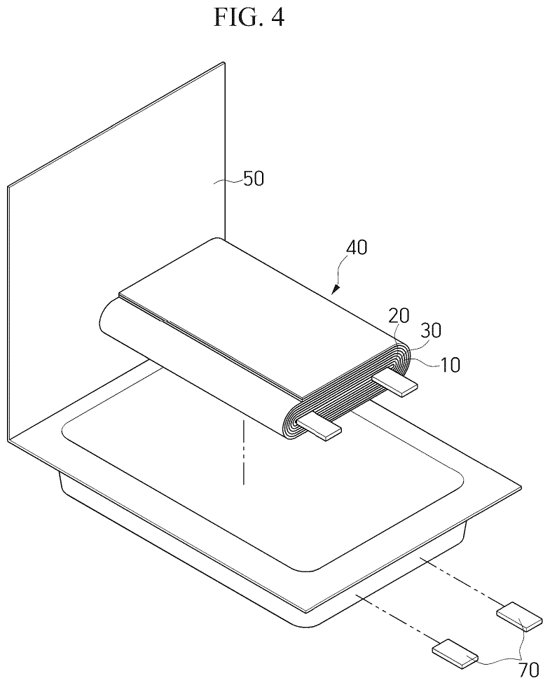

FIGS. 1 to 4 are schematic diagrams illustrating lithium secondary batteries according to one or more embodiments. FIG. 1 illustrates a cylindrical lithium secondary battery. FIG. 2 illustrates a prismatic type or kind secondary battery. FIGS. 3 and 4 illustrate a pouch type or kind secondary battery. Referring to FIG. 1 to 4, a lithium secondary battery 1 may include an electrode assembly 40 in which a separator 30 is between a first electrode plate 10 and a second electrode plate 20 and a case 50 in which the electrode assembly 40 is embedded (or accommodated). The first electrode plate 10, the second electrode plate 20, and the separator 30 may be impregnated in/with an electrolyte. As illustrated in FIG. 1, the lithium secondary battery 1 may include a sealing member 60 that seals the case 50. Furthermore, in FIG. 2, the lithium secondary battery 1 may include a first electrode lead tab 11, a first electrode terminal 12, a second electrode lead tab 21, and a second electrode terminal 22. As illustrated in FIGS. 3 and 4, the lithium secondary battery 1 may include an electrode tab 70 that plays a role as (or acts as) an electrical passage to induce a current in the electrode assembly 40 toward the outside, for example, a first electrode tab 71 and a second electrode tab 72.

The electrode assembly 40 may be formed or provided by winding and/or stacking a stack body including the first electrode plate 10, the second electrode plate 20, and the separator 30 each of which is in a plate or film shape. For the winding stack body, the winding axis of the electrode assembly 40 may be parallel (e.g., substantially parallel) to the length direction of the case. Furthermore, the electrode assembly 40 may be the stack type or kind, not the winding type or kind, but a shape of the electrode assembly 40 is not limited in one or more embodiments of the present disclosure. The first electrode plate 10 of the electrode assembly 40 may play a role as (or act as) a positive electrode, and the second electrode plate 20 thereof may play a role as (or act as) a negative electrode, and vice versa.

The first electrode plate 10 may be formed or provided by applying a first electrode active material, such as graphite and/or carbon, to a first electrode collector plate of metal foil, such as copper, a copper alloy, nickel, and/or a nickel alloy, and may include a first electrode tab (or a first uncoated part), for example, an area to which the first electrode active material has not been applied.

The second electrode plate 20 may be formed or provided by applying a second electrode active material, such as transition metal oxide, to a material of metal foil, such as aluminum or an aluminum alloy, and may include a second electrode tab (or a second uncoated part), for example, an area to which the second electrode active material has not been applied.

The separator 30 may prevent a short-circuit (or reduce a degree or occurrence of a short-circuit) between the first electrode plate 10 and the second electrode plate 20 while permitting a movement of lithium ions (or a flow of lithium ions). The separator 30 may be of a polyethylene film, a polypropylene film, and/or a polyethylene-polypropylene film, for example.

A plurality of secondary batteries that has been described by taking FIGS. 1 to 4 as examples may be gathered to constitute a plurality of battery cells and accommodated in a battery case. A battery case according to one or more embodiments of the present disclosure may include a support part that supports a hook after the hook and a hook hole are fastened and may maintain the state in which the hook and the hook hole have been fastened because the breakaway of the hook attributable to the retreat of the hook may be prevented if (e.g., when) an impact is applied to a battery pack. Hereinafter, a battery case according to one or more embodiments of the present disclosure and a method of manufacturing the battery case are described with reference to the accompanying drawings.

The secondary batteries as described in one or more embodiments by way of example with reference to FIGS. 1 to 4 may each include (or consist of) a plurality of secondary batteries to constitute a plurality of battery cells, which may be accommodated in a battery casing.

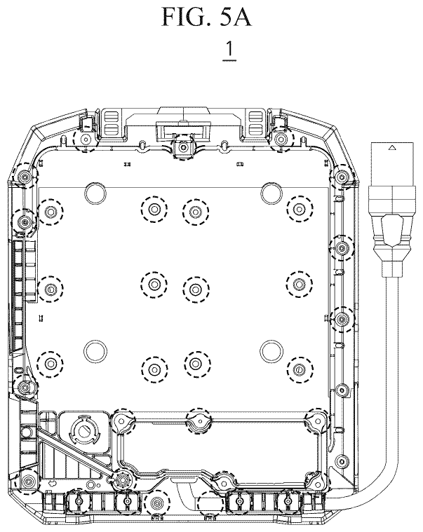

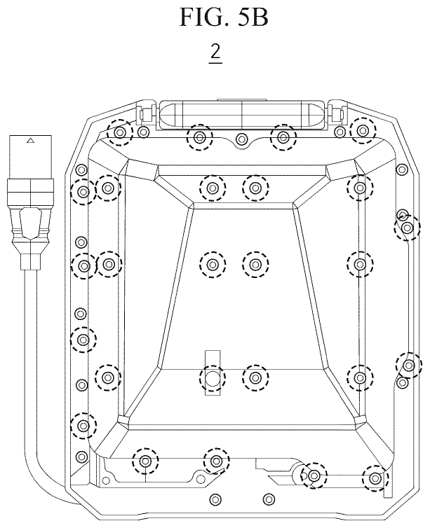

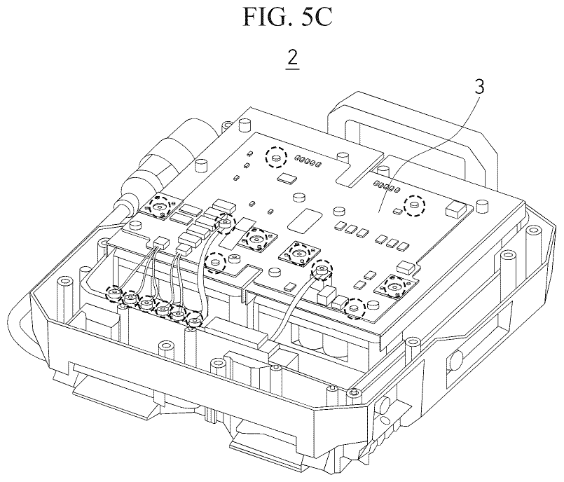

FIGS. 5A to 5D are views illustrating a casing to which a tapping screw (e.g., a self-tapping screw) is applicable according to one or more embodiments of the present disclosure.

Referring to FIGS. 5A to 5D, the battery casing may be formed or provided by combination of a first casing 1 as illustrated in FIG. 5A and a second casing 2 as illustrated in FIG. 5B. As illustrated in FIG. 5C, the second casing 2 may be equipped with (or may accommodate) a battery management system (BMS) 3 therein. For the combination of these casing, the installation of the BMS, and/or the like, a number of screws may be used, as indicated by circles in FIGS. 5A to 5C.

FIG. 5D illustrates an enlarged cross-section of a portion where a screw 4 may be coupled to the second casing 2. The screw 4 may be made of metal and be mainly or predominantly used by insertion into a body 5 made of plastic. Because the hard screw 4 is inserted into the relatively soft body 5 in this way, the body 5 made of plastic may be damaged. For example, if (e.g., when) the fastening force of the screw 4 exceeds a certain level, the fastening part of the body 5 may become weak while turning white (so-call stress whitening), or in severe cases, may be broken. For example, a tapping screw that forms a thread through tapping on a body 5 where no thread was previously formed may cause the cut by-products of the body 5 generated by tapping to remain in the fastening part of the body 5, which may lead to an increase in volume of the fastening part of the body 5, directly resulting in weakening or breakage of the body 5.

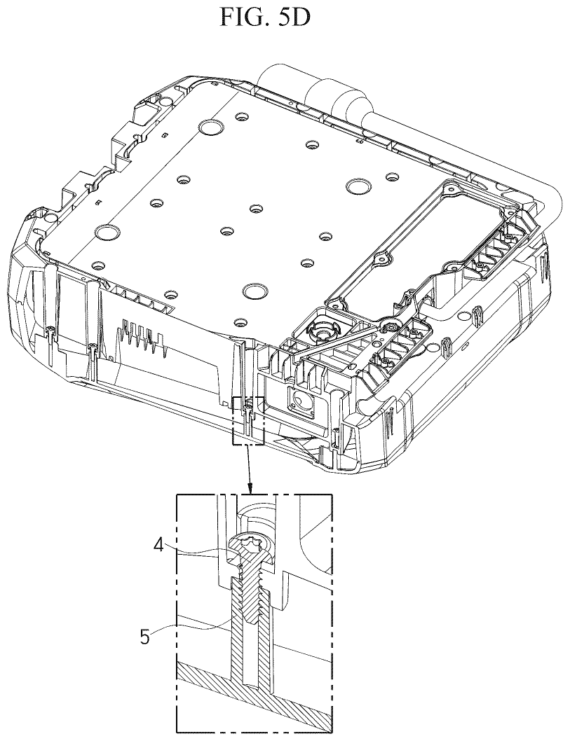

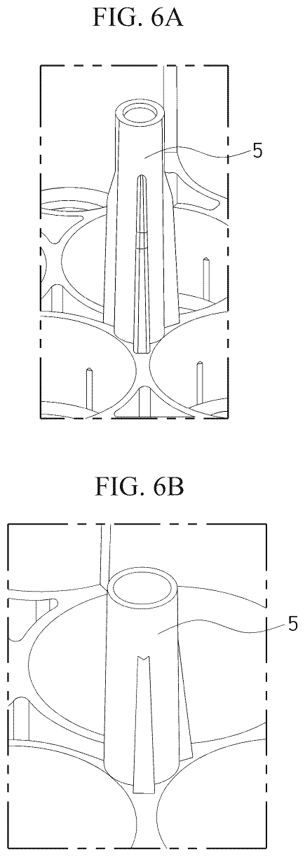

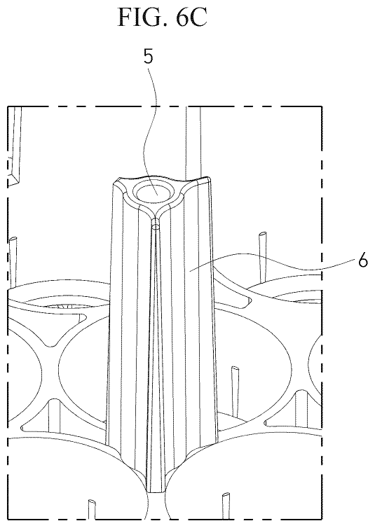

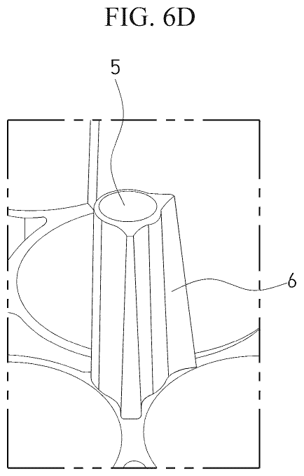

FIGS. 6A and 6B are views illustrating a body, that is generally available or generally used, to which a screw is fastened. FIGS. 6C and 6D are views illustrating the body, that is generally available or generally used, with a reinforcement member.

Referring to FIGS. 6A and 6B, if (e.g., when) the fastening force of the screw 4 exceeds a certain level as described in one or more embodiments, the fastening part of a body 5 that is generally available or generally used may become weak while turning white, or in severe cases, may be broken. Hence, a method of minimizing or reducing weakening and/or breakage by providing a reinforcement member 6 has been adopted, as illustrated in FIGS. 6C and 6D. However, this method did not solve a fundamental issue of the increase in volume of the fastening part of the body 5 due to the fact that the cut by-products of the body 5 generated by tapping remain in the fastening part of the body 5.

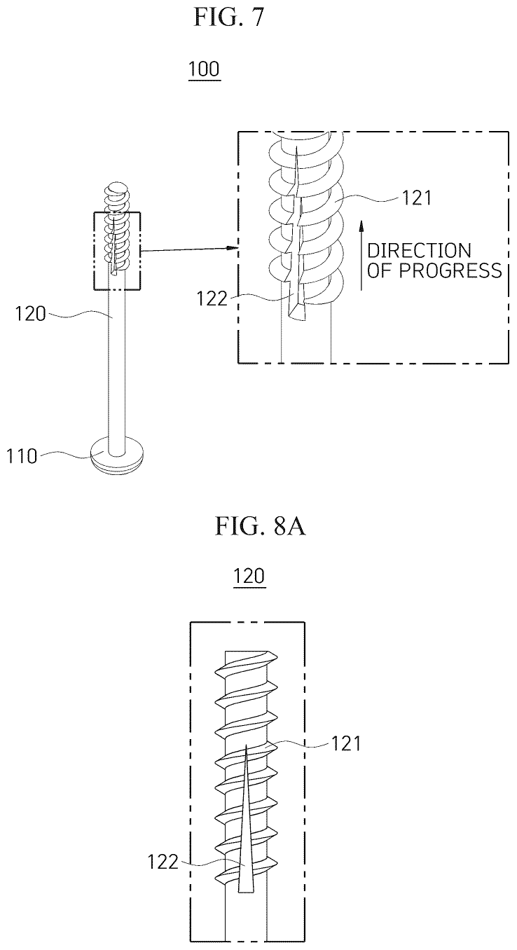

FIG. 7 is a view illustrating the tapping screw according to one or more embodiments of the present disclosure.

Referring to FIG. 7, the tapping screw, which is designated by reference numeral 100, according to one or more embodiments of the present disclosure may include a head part 110 and a screw part 120 that is beneath the head part 110 and that has a thread 121 on the outer periphery of the minor diameter circle thereof.

The screw part 120 may have a receiving groove 122 on a portion thereof. The receiving groove 122 may receive by-products cut by tapping performed on the body as the screw part 120 progresses through the body (or receive by-products from the body as the screw part 120 progresses through the body). In one or more embodiments, the receiving groove 122 may be in a direction of progress of the screw part 120. In one or more embodiments, the receiving groove 122 may extend along a length direction of the screw part 120. The tapping screw as illustrated in FIG. 7 may be a right-handed screw. Accordingly, if (e.g., when) a torque is transmitted to the screw to the right (in the right-hand or clockwise direction), the cut by-products of the body may be received in the receiving groove 122 along the left wall of the receiving groove 122.

In one or more embodiments, the receiving groove 122 may have, on the basis of the horizontal cross-sectional area of the receiving groove, an area in a range of about 90% to about 110% of the region where the thread 121 interferes with the body. Because the body is generally cut as much as the region where the thread 121 interferes with the body, the area of the receiving groove 122 may be formed or provided by about 90% to about 110% of the region where the thread 121 interferes with the body. Thus, the receiving groove 122 may receive most of the cut by-products.

According to one or more embodiments of the present disclosure, because the receiving groove 122 receives by-products cut by tapping, the degree or occurrence of physical internal stress due to the cut by-products may be suppressed or reduced to maintain or provide the strength of the fastening part.

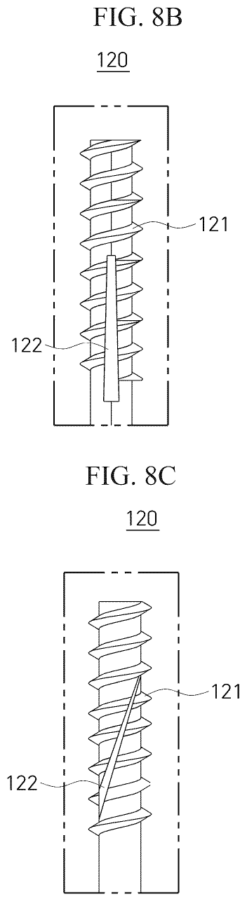

FIGS. 8A to 8C are views illustrating examples of receiving grooves for the tapping screw according to one or more embodiments of the present disclosure.

Referring to FIGS. 8A to 8C, the receiving groove 122 of the tapping screw 100 according to one or more embodiments of the present disclosure may have one or more suitable shapes as desired or needed. In one or more embodiments, the receiving groove 122 may have a width that becomes larger as the screw part 120 progresses. For example, the receiving groove 122 may have a triangular (e.g., substantially triangular) cross-sectional shape as illustrated in FIG. 8A or a trapezoidal (e.g., substantially trapezoidal) cross-sectional shape as illustrated in FIG. 8B. Accordingly, the receiving groove 122 may effectively or suitably receive the cut by-products of the body that accumulate as the screw part 120 progresses.

In one or more embodiments, as illustrated in FIG. 8C, the receiving groove 122 may be inclined at an (e.g., a set or predetermined) angle with respect to the direction of the progress of the screw part 120. If (e.g., when) the receiving groove 122 is inclined at an (e.g., a set or predetermined) angle in this way, the cut by-products may be sequentially inserted along with insertion of the tapping screw 100.

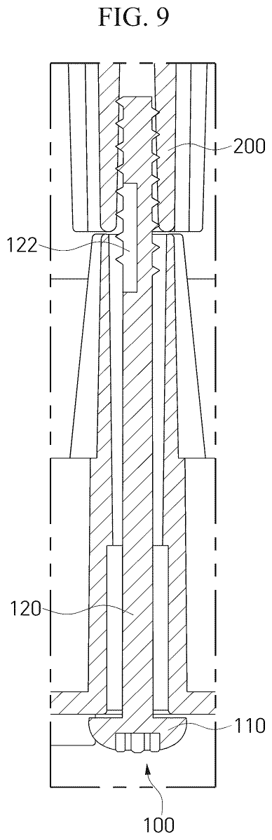

FIG. 9 is a cross-sectional view illustrating a state in which the tapping screw is coupled to a body according to one or more embodiments of the present disclosure.

FIG. 9 illustrates a state in which the screw part 120 of the tapping screw 100 moves in the direction of progress so that the tapping screw 100 may be coupled to a body 200 according to one or more embodiments of the present disclosure. In this case, the cut by-products of the body 200 may be received in the receiving groove 122. In one or more embodiments, the tapping screw 100 may be configured or arranged such that the receiving groove 122 is exposed to the outside to discharge the by-products from the receiving groove upon the completion of fastening following the progress of the screw part 120 (or upon completion of fastening of the screw part 120 to the body). In other words, as illustrated in FIG. 9, the receiving groove 122 may not completely enter the body 200 even after the fastening of the screw is completed, but a portion of the screw part may be exposed out of the body 200, thereby discharging the by-products received in the receiving groove 122.

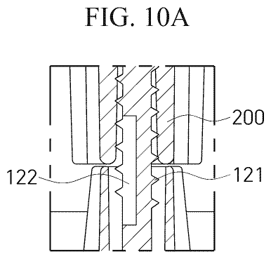

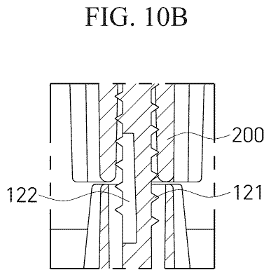

FIGS. 10A and 10B are enlarged views of examples in which the tapping screw is coupled to the body according to one or more embodiments of the present disclosure.

Referring to FIG. 10A, the receiving groove 122 of the screw part 120 of the tapping screw 100 according to one or more embodiments of the present disclosure may have a constant (e.g., substantially constant) depth in the direction of progress of the screw part 120.

In one or more embodiments, referring to FIG. 10B, the receiving groove 122 of the screw part 120 of the tapping screw 100 according to one or more embodiments of the present disclosure may have a depth that becomes larger as the screw part 120 progresses. Accordingly, the receiving groove 122 may effectively or suitably receive the cut by-products of the body 200 that accumulate as the screw part 120 progresses.

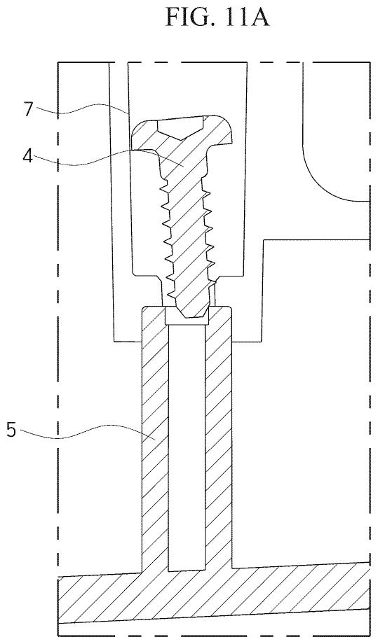

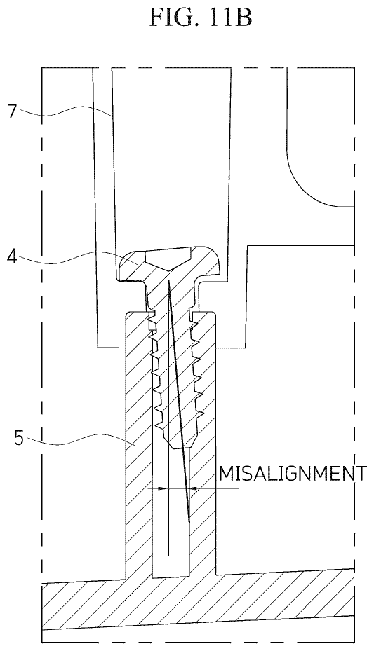

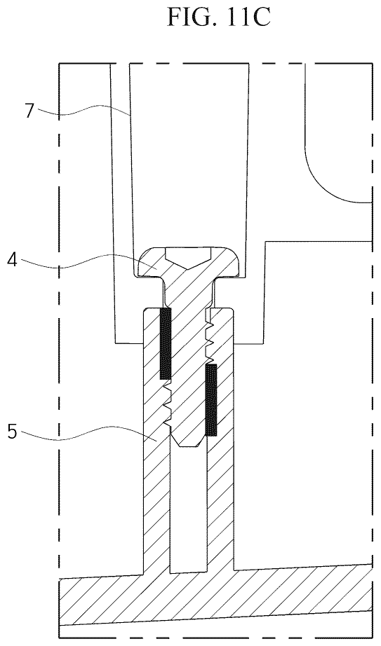

FIGS. 11A to 11C are views illustrating an issue due to vertical misalignment if (e.g., when) fastening a tapping screw that is generally available or generally used.

Referring to FIG. 11A, to fasten a tapping screw 4 that is generally available or generally used, it may be first inserted along a vertical guide 7 at the top. In this case, the tapping screw 4 may be inserted out of alignment rather than vertically, as illustrated in FIG. 11A. In this state, if (e.g., when) the screw part of the tapping screw 4 progresses to fasten the tapping screw 4 to a body 5, as illustrated in FIG. 11B, the tapping screw 4 may progress while forming or providing a thread through tapping on the body 5 with no thread. Hence, the tapping screw 4 may be fastened to the body 5 in a misaligned state. This may weaken or break the fastening part of the body 5 due to the vertical misalignment of the tapping screw 4, as illustrated in FIG. 11C. In one or more embodiments, if (e.g., when) the tapping screw 4 is fastened to the outermost portion of the casing, the weakening and/or breakage of the fastening part of the body 5 due to the vertical misalignment of the tapping screw 4 may occur more frequently and seriously because the vertical guide 7 is also not formed.

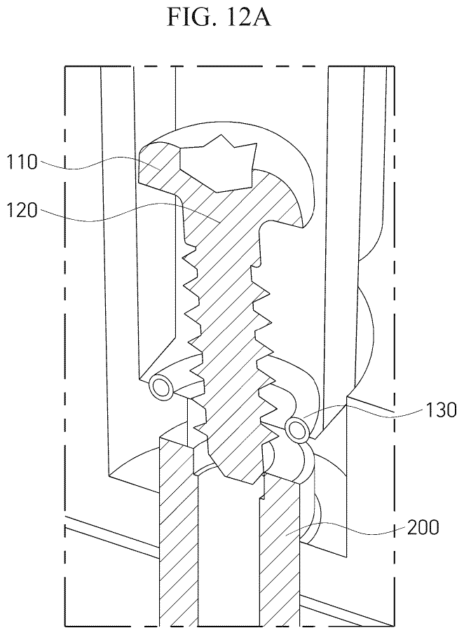

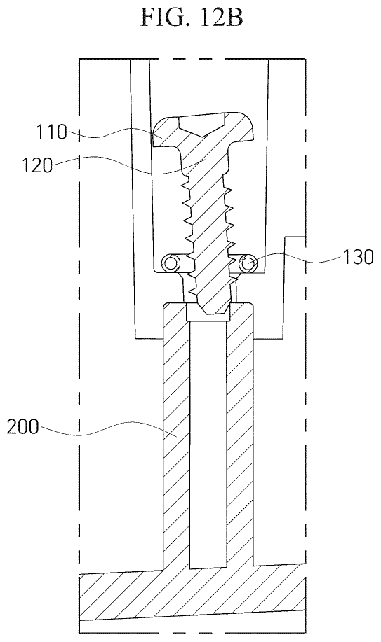

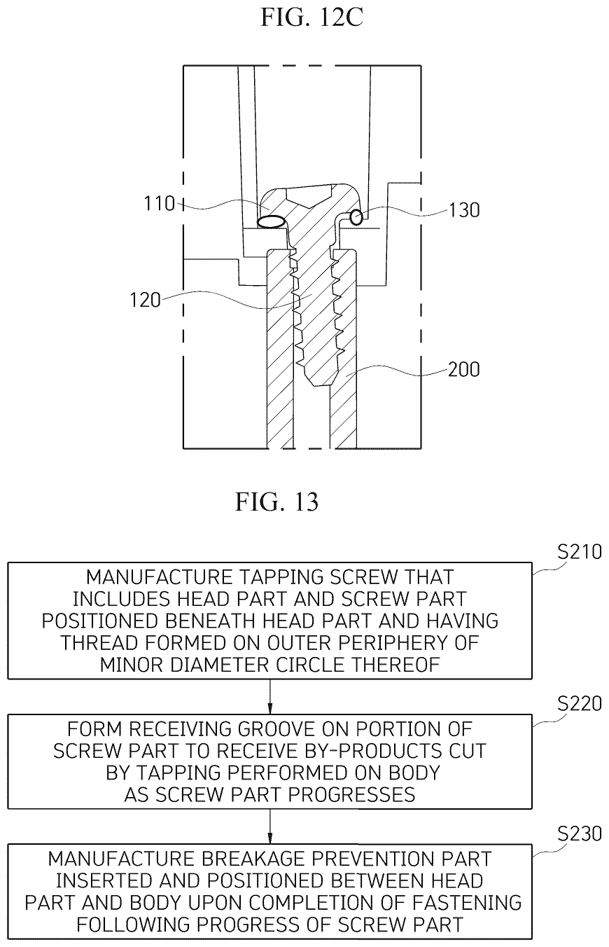

FIGS. 12A to 12C are views illustrating that the tapping screw may include a breakage prevention part according to one or more embodiments of the present disclosure.

Referring to FIGS. 12A to 12C, the tapping screw 100 according to one or more embodiments of the present disclosure may include a breakage prevention part 130 inserted and positioned or provided between the head part 110 and the body 200 upon the completion of fastening following the progress of the screw part 120. As illustrated in FIG. 12A, the breakage prevention part 130 may be inserted between the tapping screw 100 and the body 200 before the tapping screw 100 is inserted into the body 200 to fasten.

In one or more embodiments, the breakage prevention part 130 may be made of a circular (e.g., substantially circular) elastic material, such as rubber, and may be a circular (e.g., substantially circular) tube containing air as illustrated in FIG. 12B. In one or more embodiments, the breakage prevention part 130 may be made of a combination of different materials. Moreover, the breakage prevention part 130 may be formed or provided integrally with the tapping screw 100 according to one or more embodiments of the present disclosure. If (e.g., when) the breakage prevention part 130 is formed or provided integrally, the workability of the tapping screw 100 may be improved or enhanced.

If (e.g., when) the breakage prevention part 130 is included, as illustrated in FIG. 12C, the breakage prevention part 130 may be between the head part 110 and the body 200 while supporting the head part 110 if (e.g., when) the fastening of the tapping screw 100 according to one or more embodiments of the present disclosure is completed. Accordingly, even if (e.g., when) the tapping screw (100) according to one or more embodiments of the present disclosure is inserted out of alignment, the breakage prevention part 130 may be operated to generate the rubber elasticity thereof and/or the air balancing of the air contained in the tube that acts or serves as the breakage prevention part 130 to apply a force greater than a certain torque to the head part 110 upon the completion of fastening, thereby preventing or reducing deeper insertion of the tapping screw 100 and, thus, preventing or reducing the weakening or breakage of the fastening part of the body 200.

According to one or more embodiments of the present disclosure, because of the breakage prevention part 130 that is inserted and positioned or provided between the head part 110 and the body 200, the breakage of the body 200 due to the vertical misalignment of the screw during the fastening thereof may be prevented (or a degree or occurrence of such breakage of the body may be reduced), thereby ensuring or providing the fastening force of the battery pack.

FIG. 13 is a flowchart illustrating a method of manufacturing tapping screws according to one or more embodiments of the present disclosure.

Referring to FIG. 13, the method of manufacturing tapping screws according to one or more embodiments of the present disclosure may include steps S210 to S230.

Step S210 is a step of manufacturing a tapping screw that includes a head part and a screw part that is beneath the head part and that has a thread on the outer periphery of the minor diameter circle thereof.

Step S220 is a step of forming or providing a receiving groove on a portion of the screw part to receive by-products cut by tapping performed on a body as the screw part progresses through the body (or to receive by-products from a body as the screw part progresses through the body). In one or more embodiments, in step S220, the receiving groove may be in a direction of progress of the screw part. In one or more embodiments, in step S220, the receiving groove may extend along a length direction of the screw part. In one or more embodiments, in step S220, the receiving groove may have, on the basis of the horizontal cross-sectional area of the receiving groove, an area in a range of about 90% to about 110% of the region where the thread interferes with the body. In one or more embodiments, in step S220, the receiving groove may have a width that becomes larger as the screw part progresses through the body. In one or more embodiments, in step S220, the receiving groove may be inclined at an (e.g., a set or predetermined) angle with respect to the direction of the progress of the screw part. In one or more embodiments, in step S220, the receiving groove may have a depth that becomes larger as the screw part progresses through the body. In one or more embodiments, in step S220, the receiving groove may be exposed to the outside to discharge the by-products from the receiving groove upon completion of fastening following the progress of the screw part (or upon completion of fastening of the screw part to the body).

Step S230 is a step of manufacturing a breakage prevention part between the head part and the body. Step S230 is a step of manufacturing a breakage prevention part inserted and positioned or provided between the head part and the body upon the completion of fastening following the progress of the screw part.

The method of manufacturing tapping screws according to one or more embodiments of the present disclosure has been described in one or more embodiments with reference to the flowchart as presented in the drawing. For the purposes of simplicity, the method has been illustrated and described as a series of blocks, but embodiments of the present disclosure are not limited to the order of the blocks. In one or more embodiments, one or more blocks may occur in a different order or concurrently with other blocks than as illustrated and described herein, and one or more different branches, flow paths, and sequences of blocks may be implemented that achieve substantially the same or similar results. Furthermore, all of the blocks illustrated may not be desired or required to implement the method as described herein.

Meanwhile, in the description with reference to FIG. 13, each step may be further divided into one or more additional steps or combined into fewer steps, depending on the implementation of the present disclosure. In one or more embodiments, if (e.g., when) desired or necessary, one or more steps may be omitted or the order between steps may be changed. Moreover, even if (e.g., when) there are any other omitted, the contents of FIGS. 1 to 12C may be applied to the contents of FIG. 13. On the other hands, the contents of FIG. 13 may be applied to the contents of FIGS. 1 to 12C.

As is apparent from the present disclosure, according to one or more embodiments of the present disclosure, because the receiving groove receives by-products cut by tapping, the degree or occurrence of physical internal stress due to the cut by-products may be suppressed or reduced to maintain or provide the strength of the fastening part.

According to one or more embodiments of the present disclosure, because of the breakage prevention part that is inserted and positioned or provided between the head part and the body, the breakage of the body due to the vertical misalignment of the screw during the fastening thereof may be prevented (or a degree or occurrence of such breakage of the body may be reduced), thereby ensuring or providing the fastening force of the battery pack.

Hereinafter, materials which may be used in a secondary battery according to one or more embodiments of the present disclosure are described.

A compound (e.g., a lithiated intercalation compound) capable of reversible intercalation and deintercalation of lithium may be used as a positive electrode active material. For example, one type or kind or more selected from among complex oxides of metal, selected from among cobalt, manganese, nickel, and a combination of them, and lithium may be used as the positive electrode active material.

The complex oxide may be lithium transition metal complex oxide. A more detailed example of the complex oxide may include lithium nickel-based oxide, lithium cobalt-based oxide, lithium manganese-based oxide, a lithium ferrous phosphate-based compound, cobalt-free nickel-manganese-based oxide, or a combination of them.

For example, a compound that is represented as one selected from among the following chemical formulas may be used: LiₐA_{1-b}X_{b}O_{2-c}D_{c} (0.90≤a≤1.8, 0≤b≤0.5, and 0≤c≤0.05); LiₐMn_{2-b}X_{b}O_{4-c}D_{c} (0.90≤a≤1.8, 0≤b≤0.5, and 0≤c≤0.05); LiₐNi_{1-b-c}Co_{b}X_{c}O₂-_{α}D_{α} (0.90≤a≤1.8, 0≤b≤0.5, 0≤c≤0.5, and 0<α<2); LiₐNi_{1-b-c}Mn_{b}X_{c}O₂-_{α}D_{α}(0.90≤a≤1.8, 0≤b≤0.5, 0≤c≤0.5, and 0<α<2); LiₐNi_{b}Co_{c}L¹_{d}GₑO₂ (0.90≤a≤1.8, 0≤b≤0.9, 0≤c≤0.5, 0≤d≤0.5, and 0≤e≤0.1); LiₐNiG_{b}O₂ (0.90≤a≤1.8 and 0.001≤b≤0.1); LiₐCoG_{b}O₂ (0.90≤a≤1.8 and 0.001≤b≤0.1); LiₐMn_{1-b}G_{b}O₂ (0.90≤a≤1.8 and 0.001≤b≤0.1); LiₐMn₂G_{b}O₄ (0.90≤a≤1.8 and 0.001≤b≤0.1); LiₐMn_{1-g}G_{g}PO₄ (0.90≤a≤1.8 and 0≤g≤0.5); Li_{(3-f)}Fe₂(PO₄)₃ (0≤f≤2); and LiₐFePO₄ (0.90≤a≤1.8).

In the foregoing chemical formulae, A may be nickel (Ni), cobalt (Co), manganese (Mn), or a combination of them. X may be aluminum (Al), Ni, Co, Mn, chromium (Cr), iron (Fe), magnesium (Mg), strontium (Sr), vanadium (V), a rare earth element, or a combination of them; D may be oxygen (O), fluorine (F), sulfur(S), phosphorus (P), or a combination of them. G may be Al, Cr, Mn, Fe, Mg, lanthanum (La), cerium (Ce), Sr, V, or a combination of them. L¹ may be Mn, Al, or a combination of them.

A positive electrode for a lithium secondary battery may include a current collector and a positive electrode active material layer on the current collector. The positive electrode active material layer may include the positive electrode active material and may further include a binder and/or a conductive (e.g., electrically conductive) material.

The content (e.g., amount) of the positive electrode active material may be about 90 wt% to about 99.5 wt% based on 100 wt% of the positive electrode active material layer. The content (e.g., amount) of the binder and the conductive (e.g., electrically conductive) material may be about 0.5 wt% to about 5 wt% based on 100 wt% of the positive electrode active material layer.

Aluminum (Al) may be used as the current collector, but embodiments of the present disclosure are not limited thereto.

A negative electrode active material may include a material capable of reversible intercalation/de-intercalation with respect to lithium ions, lithium metal, an alloy of lithium metal, a material capable of doping and dedoping with respect to lithium, or transition metal oxide.

The material capable of reversible intercalation/de-intercalation with respect to lithium ions may include a carbon-based negative electrode active material, for example, crystalline carbon, amorphous (e.g., non-crystalline) carbon, or a combination of them. An example of the crystalline carbon may include graphite, such as natural graphite and/or synthetic graphite. Examples of the amorphous (e.g., non-crystalline) carbon may include soft carbon, hard carbon, mesophase pitch carbide, and/or fired coke.

A silicon (Si)-based negative electrode active material and/or a tin (Sn)-based negative electrode active material may be used as the material capable of doping and dedoping with respect to lithium. The Si-based negative electrode active material may be silicon, a silicon-carbon composite, silicon oxide (e.g., SiOₓ, where 0<x≤2; e.g., SiO₂), a Si-based alloy, or a combination of them.

The silicon-carbon composite may be a composite of silicon and amorphous (e.g., non-crystalline) carbon. According to one or more embodiments, the silicon-carbon composite may include silicon particles and may have a form in which amorphous (e.g., non-crystalline) carbon has been coated on surfaces of silicon particles.

The silicon-carbon composite may further include crystalline carbon. For example, the silicon-carbon composite may include a core including crystalline carbon and silicon particles and an amorphous (e.g., non-crystalline) carbon coating layer on a surface of the core.

A negative electrode for a lithium secondary battery may include a current collector and a negative electrode active material layer on the current collector. The negative electrode active material layer may include the negative electrode active material and may further include a binder and/or a conductive (e.g., electrically conductive) material.

For example, the negative electrode active material layer may include the negative electrode active material of about 90 wt% to about 99 wt%, the binder of about 0.5 wt% to about 5 wt%, and the conductive (e.g., electrically conductive) material of about 0 wt% to about 5 wt%.

A nonaqueous (e.g., water-insoluble)-based binder, an aqueous (e.g., water-soluble)-based binder, a dry binder, or a combination of them may be used as the binder. If (e.g., when) the aqueous (e.g., water-soluble)-based binder is used as a binder for the negative electrode, the binder for the negative electrode may further include a cellulose-series compound (or a cellulose-based compound) capable of assigning or increasing viscosity.

One selected from among nickel foil, stainless steel foil, titanium foil, nickel foam, copper foam, a polymer base (or a polymer derivative) on which a conductive (e.g., electrically conductive) metal has been coated, and a combination of them may be used as a current collector for the negative electrode.

An electrolyte for a lithium secondary battery may include a nonaqueous (e.g., water-insoluble) organic solvent and lithium salts.

The nonaqueous (e.g., water-insoluble) organic solvent may play a role as (or act as) a medium through which ions that are involved in an electrochemical reaction of a battery may move.

The nonaqueous (e.g., water-insoluble) organic solvent may be a carbonate-based solvent, an ester-based solvent, an ether-based solvent, a ketone-based solvent, an alcohol-based solvent, an aprotic solvent, or a combination of them. The carbonate-based solvent, the ester-based solvent, the ether-based solvent, the ketone-based solvent, the alcohol-based solvent, or the aprotic solvent may be used solely, or two types or kinds or more of them may be mixed and used as the nonaqueous (e.g., water-insoluble) organic solvent.

Furthermore, if (e.g., when) the carbonate-based solvent is used, annular carbonate and chain carbonate may be mixed and used.

A separator may be between the positive electrode and the negative electrode depending on the type or kind of lithium secondary battery. Polyethylene, polypropylene, and polyvinylidene fluoride, or a multi-layer having two or more layers of them may be used as the separator.

The separator may include a porous base, and a coating layer including an organic matter, an inorganic matter, or a combination of them that is on one side or both sides (e.g., two opposing sides) of the porous base.

The organic matter may include a polyvinylidene fluoride-based heavy antibody and/or a (meth)acrylic polymer.

The inorganic matter may include inorganic particles selected from among Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination of them, but embodiments of the present disclosure are not limited thereto.

The organic matter and the inorganic matter may have a form in which the organic matter and the inorganic matter have been mixed in one coating layer or a form in which a coating layer including the organic matter and a coating layer including the inorganic matter have been stacked.

While the subject matter of the present disclosure has been described in connection with what is presently considered to be practical embodiments, it is to be understood that the present disclosure is not limited to the disclosed embodiments. In contrast, it is intended to cover one or more suitable modifications and equivalent arrangements included within the spirit and scope of the appended claims and equivalents thereof. It therefore will be understood that one or more embodiments described above are just illustrative but not limitative in all aspects.

What is claimed is:

1. A tapping screw comprising:
a head part; and
a screw part beneath the head part and having:
a thread on an outer periphery of a minor diameter circle thereof; and
a receiving groove on a portion thereof to receive by-products from a body as the screw part progresses through the body.

2. The tapping screw as claimed in claim 1, wherein the receiving groove extends along a length direction of the screw part.

3. The tapping screw as claimed in claim 1, wherein the receiving groove has, on the basis of a horizontal cross-sectional area of the receiving groove, an area in a range of 90% to 110% of the region where the thread interferes with the body.

4. The tapping screw as claimed in claim 2, wherein the receiving groove has a width that becomes larger as the screw part progresses through the body.

5. The tapping screw as claimed in claim 4, wherein the receiving groove has a triangular cross-sectional shape.

6. The tapping screw as claimed in claim 4, wherein the receiving groove has a trapezoidal cross-sectional shape.

7. The tapping screw as claimed in claim 2, wherein the receiving groove is inclined at an angle with respect to the direction of the progress of the screw part.

8. The tapping screw as claimed in claim 2, wherein the receiving groove has a depth that becomes larger as the screw part progresses through the body.

9. The tapping screw as claimed in claim 1, wherein the receiving groove is exposed to the outside to discharge the by-products from the receiving groove upon completion of fastening of the screw part to the body.

10. The tapping screw as claimed in claim 1, further comprising a breakage prevention part between the head part and the body.

11. The tapping screw as claimed in claim 10, wherein the breakage prevention part is a circular elastic member.

12. The tapping screw as claimed in claim 10, wherein the breakage prevention part is a circular tube comprising air.

13. A method of manufacturing tapping screws, the method comprising:
manufacturing a tapping screw comprising a head part and a screw part beneath the head part and having a thread on an outer periphery of a minor diameter circle thereof; and
forming a receiving groove on a portion thereof to receive by-products from a body as the screw part progresses through the body.

14. The method as claimed in claim 13, wherein in the forming of the receiving groove, the receiving groove extends along a length direction of the screw part.

15. The method as claimed in claim 13, wherein in the forming of the receiving groove, the receiving groove has, on the basis of a horizontal cross-sectional area of the receiving groove, an area in a range of 90% to 110% of the region where the thread interferes with the body.

16. The method as claimed in claim 14, wherein in the forming of the receiving groove, the receiving groove has a width that becomes larger as the screw part progresses through the body.

17. The method as claimed in claim 14, wherein in the forming of the receiving groove, the receiving groove is inclined at an angle with respect to the direction of the progress of the screw part.

18. The method as claimed in claim 14, wherein in the forming of the receiving groove, the receiving groove has a depth that becomes larger as the screw part progresses through the body.

19. The method as claimed in claim 13, wherein in the forming of the receiving groove, the receiving groove is exposed to the outside to discharge the by-products from the receiving groove upon completion of fastening of the screw part to the body.

20. The method as claimed in claim 13, further comprising manufacturing a breakage prevention part between the head part and the body upon completion of fastening of the screw part to the body.
